(19) United States
(12) Patent Application Publication
(10) Pub. No.: US 2025/0033145 A1
(43) Pub. Date: Jan. 30, 2025

(54) POSITION DETECTION OF JOINING PARTNERS

(71) Applicant: TRUMPF Laser GmbH, Schramberg (DE)

(72) Inventors: Julia Ziegler, Rottweil (DE); Andreas Jahn, Dornhan (DE); Andreas Fehlner, Rottweil (DE)

(21) Appl. No.: 18/912,627

(22) Filed: Oct. 11, 2024

Related U.S. Application Data
(63) Continuation of application No. PCT/EP2023/059179, filed on Apr. 6, 2023.

(30) Foreign Application Priority Data
Apr. 14, 2022 (DE) 10 2022 109 221.6

(51) Int. Cl. B23K 26/21; G06T 7/00; G06T 7/73

(52) U.S. Cl. CPC B23K 26/21; G06T 7/0004; G06T 7/73; G06T 2207/10024; G06T 2207/20084; G06T 2207/30136

(57) ABSTRACT

A method for determining a position of joining partners for a joining process includes providing the joining partners in a joining position, capturing a real image of the positioned joining partners, generating a false color image based on the real image, and determining, based on the false color image, at least one item of information about the position of at least one of the joining partners.

### CROSS REFERENCE TO RELATED APPLICATIONS

This application is a continuation of International Application No. PCT/EP2023/059179 (WO 2023/198603 A1), filed on Apr. 6, 2023, and claims benefit to German Patent Application No. DE 10 2022 109 221.6, filed on Apr. 14, 2022. The aforementioned applications are hereby incorporated by reference herein.

### FIELD

Embodiments of the present invention relate to the field of joining. In particular, embodiments of the present invention relate to a method for determining the position of joining partners for a joining process.

### BACKGROUND

When welding component joints, it is important to know the exact position of the joining partners to be welded. Based on the position information, the welding path (in particular the position of the welding path) can be precisely adjusted in order to create the best possible welded joint. Clamping devices are usually used for rough positioning of the joining partners. However, a reliable, precisely reproducible positioning of joining partners is often not possible even with the available clamping devices. In laser welding, computer programs with position detection algorithms are therefore used to detect the exact position or positioning of the joining partners in relation to each other using a camera image. However, the detection only works accurately if the image areas of the camera image relevant for the position detection stand out in high contrast from the surrounding image areas.

In so-called hairpin technology, which is used in the production of stators for electric motors or generators, the ends of two adjacent hairpins are welded together in order to create plug-in coils, for example. The ends are roughly positioned in a joining position by means of a positioning device for this purpose. In order to better determine the exact position of the hairpin ends in relation to one another, it is known to use hairpins with evenly cut end faces. The position of the even end faces of the hairpins can be reliably detected due to sufficient contrast using known position detection algorithms, as shown in FIG. 2a. However, creating even joining surfaces is, in many cases, associated with additional effort and thus increased costs.

### SUMMARY

Embodiments of the present invention provide a method for determining a position of joining partners for a joining process. The method includes providing the joining partners in a joining position, capturing a real image of the positioned joining partners, generating a false color image based on the real image, and determining, based on the false color image, at least one item of information about the position of at least one of the joining partners.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows the sequence of a method according to embodiments of the invention;

FIG. 2 shows a real image of two hairpins in a welding position, wherein the ends of the hairpins to be welded have even end faces;

FIG. 3a shows a real image of two hairpins in a welding position, wherein the ends of the hairpins to be welded have uneven end faces;

FIG. 3b shows a false color image (here a binary image) based on the real image shown in FIG. 3a, according to some embodiments; and

FIG. 4 schematically shows a laser welding device according to embodiments of the invention.

### DETAILED DESCRIPTION

Embodiments of the present invention can improve the possibilities for automated position detection of joining partners using position detection algorithms.

According to a first aspect of the invention, a method for determining the position of joining partners for a joining process is provided. The method can preferably precede a joining process for joining the joining partners and serve to prepare the joining process. In a first step of the method, the joining partners are provided in a joining position. For rough alignment of the joining partners, the joining partners can be fixed in the joining position by means of a positioning device. The positioning device usually allows for a movement clearance of the joining partners, which is why the joining partners can have a small offset (such as a few millimeters) or a small distance (such as a gap of a few millimeters or a few tenths of a millimeter) in relation to one another. In a second method step, a real image of the joining partners positioned in the joining position is captured. In particular, a camera can be used for this purpose. The real image is a raster graphic that depicts the field of view of the camera. A false color image is generated from the real image in a subsequent, third method step. In the context of the present disclosure, a false color image is to be understood as a digital raster graphic (also referred to as a pixel graphic), the pixels of which can only assume one of at least two predetermined colors, in particular black or white and/or an intermediate shade of gray. When using shades of gray as colors in a false color image, it is usually important to ensure that each shade of gray has a clearly recognizable contrast to every other color used. When using only two colors, the false color image can be a binary image. The false color image can visually highlight items of information, in particular regarding the position and/or geometry of the joining partners, which are relevant for joining the joining partners. Based on the false color image, at least one item of information about the position of at least one of the joining partners is then determined (in a fourth method step). In particular, the position of at least one of the joining partners can be determined with respect to the position and/or alignment of a joining optics, in particular a laser welding head. The reference point for the position of the joining optics can, in particular, be a tool center point (TCP) of the joining optics. In order to determine the position information or in addition to determining the position information, a respective shape and/or size of the joining partners can be determined, for example.

According to a preferred variant, the false color image can be generated from the real image using a deep convolutional neural network (also referred to as “CNN” for short), in particular a modified U-Net.

For more reliable processing of image data even with irregular contrast conditions, an intelligent filter is therefore provided prior to an image evaluation (in particular a position detection) according to embodiments of the invention, which generates the false color image. In this false color image, the features relevant to the joining process are shown in one color (such as white) and the features not relevant to the joining process (such as the clamping device or sections of the joining partners not relevant to the joining process) are shown in the other color (such as black). It is understood that more than just two feature classes can also be represented by means of the false color image, wherein preferably a separate color is used for the representation of each feature class, each of which has a sufficiently clear contrast with respect to any other color used. Due to the optimal contrast between relevant and irrelevant features, the proposed method therefore allows for robust detection of the position or positioning of joining partners in order to achieve an optimized preparation of a joining process. In particular, computer programs with known component and position detection algorithms can be used to easily and automatically identify items of information about the position of the joining partners based on the false color image and derive certain joining settings for a later joining process.

Preferably, based on the determined position information, a relative position of the joining partners to each other can be verified in a fifth method step. In this case, the method steps four and five can essentially run in parallel.

Furthermore, a warning can be output if, when verifying the position information and/or an item of information relating to the geometry of at least one of the joining partners, an impermissible position and/or an impermissible geometry for the joining of the joining partners of at least one of the joining partners is ascertained. For example, a warning can be output if at least one of the joining partners has a shape or size that is outside of predetermined limits for the shape or size of the joining partner in question. Furthermore, a warning can be output, for example, if the joining partners have an impermissible offset with respect to one another or are positioned too far apart. In addition or as an alternative to outputting a warning in the event of a critical geometry or position of the joining partners, provision can be made for a later joining process to not be carried out without an additional manual approval.

The step of verification can also comprise specifying processing settings for joining the joining partners. In particular, based on the position information, a movement path or the position of a predetermined movement path can be specified, along which movement path a laser beam is moved over the surface of the joining partners for local melting of the joining partners.

In a further method step, the method can comprise joining of the joining partners using the specified processing settings in a laser welding process. In this case, the claimed method can be implemented as part of a laser welding process.

In particular, if the claimed method is implemented as part of a laser welding process, the real image can be captured from a direction perpendicular to a processing plane. In other words, the real image can represent a top view of the processing point of the joining partners. The processing plane is typically located in the region of the surface of the joining partners and, in a laser welding process, extends approximately transverse to the direction of propagation of the processing laser beam in the region of a beam focus of the processing laser beam. In a laser welding process, the real image can be captured by means of a camera through the beam path of the processing laser beam. By aligning the used camera concentrically to the beam path of the processing laser beam, the real image accordingly always shows the field of view of the processing optics. In this way, the method described can also be used to easily determine the relative position of the joining partners with respect to the position of the processing optics or to the position of a tool center point of the used joining device.

The false color image generated from the real image can preferably have a resolution corresponding to a resolution of the real image. In this regard, one of the at least two predetermined colors can be assigned to each pixel of the real image in order to generate the false color image. The color assignment can preferably be based on the assignment of the respective pixel to a predetermined feature class. This means that at least two feature classes can be predetermined for generating the false color image. For example, one feature class can be defined as the surface of at least one of the joining partners, while a second feature class is defined as the background. Using an artificial intelligence (AI) that has been trained to assign pixels to one of the defined classes, a probability can be determined for each pixel with respect to it belonging to one of the predetermined feature classes. If the probability is greater than a predetermined threshold value, then the corresponding pixel can be assigned to the feature class in question. As already described above, the AI can preferably be implemented as a deep convolutional neural network, preferably as a U-Net/U-Net derivative, which has been optimized/trained for the situation and runtime in question. It is understood that more than two feature classes can also be predetermined for generating the false color image. For example, different joining partners or additionally the components of a positioning device can each be assigned to different feature classes and thus different colors of the false color image.

The joining partners can, for example, be workpieces that are to be welded together. For example, the joining partners can be metallic, rod-shaped conductor elements, so-called hairpins (essentially wires bent in a U-shape), which are to be welded together to form an electrical connection. In particular, the hairpins can be made of copper or a copper-containing material, or of aluminum or an aluminum-containing material, for example.

According to a further aspect of the invention, a laser welding device for joining two joining partners is provided. The laser welding device comprises a positioning device for positioning the joining partners in a joining position. The positioning device can, for example, be a holder that fixes the joining partners in a certain position (with a certain amount of play) in relation to one another. The laser welding device further comprises a laser beam source for providing a processing laser beam and a laser welding head with laser welding optics for aligning and focusing the processing laser beam in the direction of the joining partners. The laser beam source can, for example, be a solid-state laser, in particular a fiber laser or a disc laser. The laser beam can be guided from the laser beam source to the laser welding head, at least in sections, by means of an optical fiber. For example, scanner optics or also fixed optics can be used as laser welding optics. The laser welding device further comprises an image capture device for capturing a real image of the joining partners in the joining position. In particular, the image capture device can be a camera, for example a gray-scale camera with a resolution in the megapixel range. The laser welding device further comprises an image processing device for generating a false color image based on the real image and a measuring device for determining at least one item of information about the position of at least one of the joining partners based on the false color image.

The laser welding device can further comprise a verification device for verifying, based on the at least one position information, the position and/or a geometry of at least one of the joining partners. The image processing device, the measuring device and the verification device can each be implemented as a computer program (product) on a common computer, which can also be used to control the camera, for example.

The verification device can also be designed to output a warning. For example, a warning can be output if, when verifying the position and/or geometry, an impermissible position and/or an impermissible geometry for the joining of the joining partners of at least one of the joining partners is ascertained. In addition or as an alternative to the warning, the verification device can be designed to send a signal to a control device of the laser welding device that prohibits a welding process due to impermissible position or geometry information of the joining partners unless the welding process is manually approved.

The verification device can further be designed to specify processing settings for laser welding of the joining partners by means of the laser welding device based on the at least one position information. In particular, the verification device can send instructions for positioning and moving the laser processing beam to the control device of the laser welding device based on a detected relative position of the joining partners with respect to the laser welding head.

According to a further aspect of the invention, a computer program product is provided that contains computer-readable instructions for carrying out a method according to one of the variants described above on a joining device, in particular on a laser welding device according to one of the variants described above.

Identical or functionally identical elements are designated with the same reference signs in the figures.

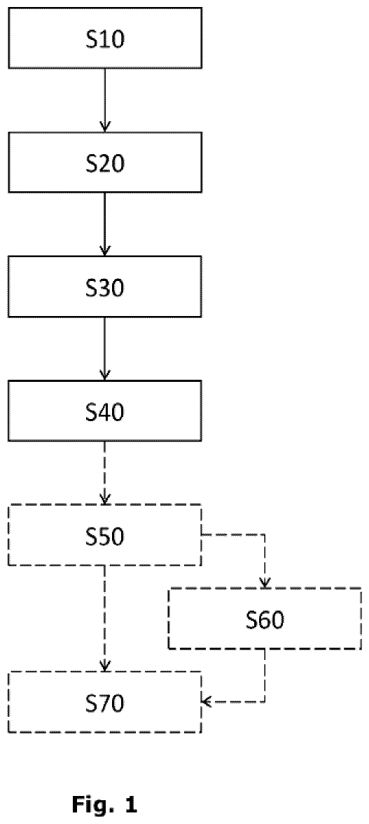

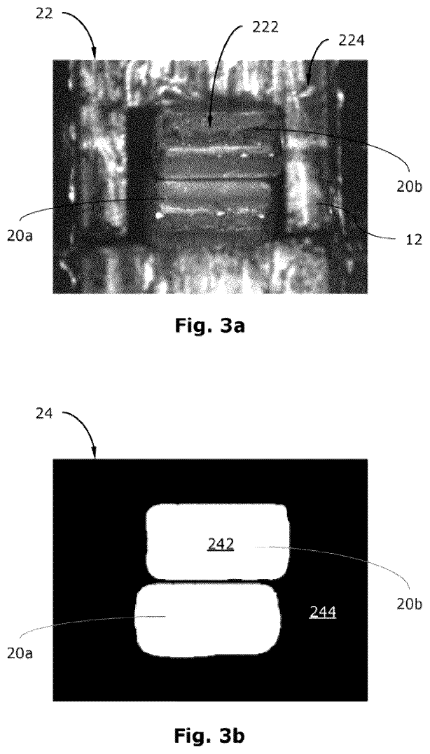

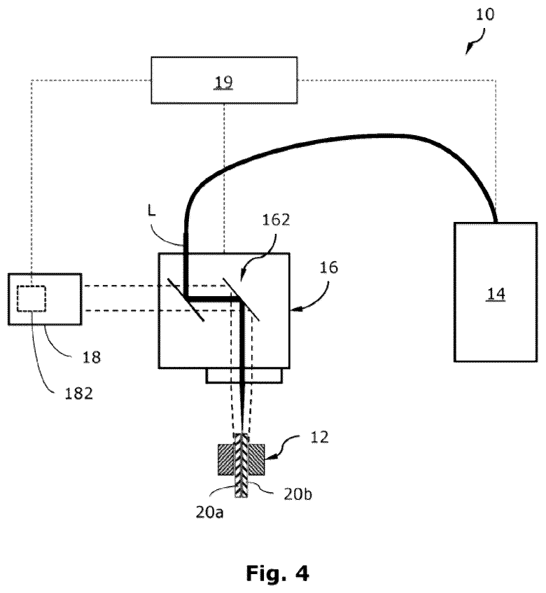

FIG. 1 schematically shows the sequence of a method according to embodiments of the invention for determining the position of joining partners 20a, 20b (cf. FIG. 4, for example) for a joining process. In a first step, the method comprises providing S10 the joining partners 20a, 20b in a joining position. In a second step S20, a real image of the positioned joining partners is captured (cf. also real image 22 according to FIG. 3a). In a third step S30, a false color image is generated based on the real image 22 (cf. also binary image 24 according to FIG. 3b). In a fourth step S40, at least one item of information about the position of at least one of the joining partners 20a, 20b is determined based on the false color image 24.

In an optional, fifth step S50, the position and/or geometry of at least one of the joining partners 20a, 20b can be verified based on the item of information obtained in step S40.

In an optional, sixth method step S60, a warning can be output if, when verifying S50 the position and/or geometry, an impermissible position and/or an impermissible geometry for the joining of the joining partners 20a, 20b of at least one of the joining partners 20a, 20b is ascertained.

Preferably, based on the verified position and/or geometry information of the joining partners 20a, 20b, settings for a joining process can be specified automatically and the joining partners 20a, 20b can be welded together in a seventh step S70, in particular in a laser welding process, using the specified settings. In this regard, specifying settings for the joining process can comprise, in particular, specifying the positioning (or position) of a welding path predetermined per se and/or specifying coordinates for the starting point of the welding path.

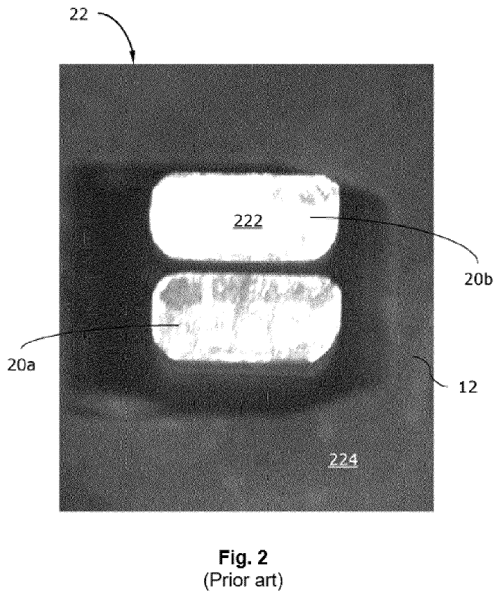

FIG. 2 shows a top view of the joining surfaces of two hairpins 20a, 20b to be welded together. “Hairpin” technology is a winding technology for stators in electric motors and generators in which multiple essentially U-shaped conductor elements—the so-called “hairpins”—are welded together in pairs at their ends in order to create a coil winding. The name “hairpin” comes from the U-shape of the bent conductor elements, which is reminiscent of the shape of a hairpin. In order to weld two hairpins 20a, 20b, a focused processing laser beam L (cf. FIG. 4) is moved along a processing path (for example in a circular pendulum movement) over the joining surfaces at the ends of the hairpins 20a, 20b. The energy introduced by means of the processing laser beam L puts the material of the hairpins 20a, 20b into a molten state so that a common welding bead is formed, which connects the two hairpins 20a, 20b to one another. As over 200 pairs of hairpins may have to be welded for an electric motor—depending on the design—it is essential for the process to be conducted in a fast and robust manner. For a good welding result, it is important that the welding process, and in particular the position of the welding path, is matched to the position of the hairpin ends to be joined. For precise position detection of the hairpins 20a, 20b, image processing programs are therefore used which determine a position of the hairpins 20a, 20b, in particular relative to the position or alignment of the welding optics used, based on a captured image. Based on the detected position of the joining partners 20a, 20b, the position and/or the starting point of the welding path is then adjusted for the welding process. For automated image processing, a high-contrast image of the hairpin ends is needed in which the contour of the hairpin ends relevant for welding stands out from the background (for example other hairpin regions, a clamping device and so forth). It is therefore known from the prior art to cut the ends of the hairpins smoothly so that they have a bare, even surface to the extent possible. This surface reflects the light of a camera illumination and stands out clearly from the surroundings in the real image 22 of the camera so that the generated real image 22 can be used for automated position detection by means of a conventional position detection algorithm.

Since the production of hairpins 20a, 20b with bare, even end faces requires complex additional processing steps (such as cutting off the hairpin ends with an expensive cutting system), embodiments of the present invention provide a solution by means of which uneven or contaminated joining partners (such as the hairpin ends according to FIG. 3a) can also be welded together reliably and accurately using known position detection algorithms. The solution according to embodiments of the invention is explained in more detail below with reference to FIGS. 3a, 3b and 4 using the hairpin example. FIG. 3a shows a real image 22 of the ends of two hairpins 20a, 20b which are positioned in a positioning device 12 for laser welding. In this case, the ends of the hairpins 20a, 20b have a roof-shaped structure, which results from a preceding processing step of the hairpins 20a, 20b. Due to the surface finish of the hairpin ends, the real image 22 according to FIG. 3a does not exhibit a sufficiently strong contrast between those image areas 222 that show hairpin ends and the adjacent image areas 224, which is why the position of the hairpin ends relative to each other cannot be reliably determined using conventional position detection algorithms.

As is also known from the prior art, the real image 22 is captured by means of a camera 18 (for example a monochrome industrial camera with a resolution of 1.5 MPx) of a laser welding system 10 that is aligned coaxially to the processing laser beam L (cf. FIG. 4). In particular, the optical axis of the camera 18 is, in this regard, coupled into the welding optics 162 in the laser welding head 16 of the laser welding device 10 via a partly transparent mirror. In this way, the camera image shows the processing region of the processing laser beam L at all times. The processing laser beam L is, in turn, provided from a laser beam source 14 to the laser welding head 16 via a fiber optic cable and focused on the ends of the hairpins 20a, 20b via the welding optics 162, which can be designed as scanner optics with movable scanner mirrors or lenses, for example. The laser welding device 10 can be controlled by means of a central control device 19.

The real image 22 captured by the camera 18 (cf. FIG. 3a) is transferred to a deep convolutional neural network of an image processing device 182, which processes the real image 22 and generates a false color image 24, here in the form of a binary image 24, with the same resolution as the real image 22 as an output. The preferred neural network used for image transformation is a U-Net/U-Net derivative, which has been optimized for the situation and runtime in question. In the generated binary image 22, the features relevant to the welding process are highlighted. This means that those pixels of the real image 22 that can be assigned to a surface of one of the hairpins 20a, 20b as a feature class (with sufficient probability) are colored white, and those pixels of the real image 22 that can be assigned to the “background” feature class are colored black. As a result, the image areas 242 recognized as the surface of the hairpins 20a, 20b are shown in white and stand out clearly from the black background 244.

The binary image 24 is now transferred to a measuring device 182 instead of the real image 22 according to the conventional procedure, which determines information about the position and/or geometry of the hairpins 20a, 20b. By means of a verification device 182, the information obtained can then be verified with respect to their suitability for the welding process and, based on the position information, welding settings (in particular the shape and/or position of the welding path to be traversed by the laser beam L) can be specified for the laser welding process. For this purpose, the verified information about the position of the hairpin ends can be transferred from the verification device to the central control device 19, which controls the laser welding device 10 in accordance with the predetermined welding settings. When verifying the position and/or geometry of the hairpin ends, it is possible in particular to verify whether predetermined position limits of the hairpin ends are maintained, whether a gap between the hairpins 20a, 20b is within a predetermined tolerance range, or whether the cross-section of a hairpin 20a, 20b exceeds or falls below a predetermined size range. If it is ascertained in this regard that a predetermined tolerance limit is not being maintained, the verification device 182 can output a warning signal and/or stop a joining process in progress in collaboration with the control device 19.

According to the structure of the laser welding device 10 shown in FIG. 4, the image processing device, the measuring device and the monitoring device can be implemented in a common computer unit 182. The computer unit 182 can be a Panel PC for image monitoring.

In the system described herein, the neural network utilized by the image processing device 182 can be regarded as an intelligent filter that highlights the features of the captured real image 22 that are relevant to the welding process for automated image processing, thereby simplifying the position detection. In this regard, detection is not limited to one feature or feature class, but any number of feature classes can be detected in an image and highlighted in a single false color image with two or more colors in order to reduce process times. By determining the feature region with pixel accuracy (in this case the surface of the hairpin ends), downstream algorithms can still perform plausibility checks and compare the calculated/detected region with an expected region. This is difficult to implement with classic intensity-based algorithms and can also have a positive effect on the robustness of the process.

The position detection of joining partners 20a, 20b according to embodiments of the invention allows for a reliable joining of the joining partners 20a, 20b. In addition, in some processes the effort (costs) involved in pre-processing the joining partners 20a, 20b (for example, the accurate cutting of the hairpin ends) can be reduced.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining a position of joining partners for a joining process, the method comprising:
providing the joining partners in a joining position;
capturing a real image of the positioned joining partners;
generating a false color image based on the real image; and
determining, based on the false color image, at least one item of information about the position of at least one of the joining partners.

2. The method according to claim 1,
wherein the false color image is generated from the real image using a deep convolutional neural network.

3. The method according to claim 1, further comprising:
verifying, based on the at least one item of information, a relative position of the joining partners to each other.

4. The method according to claim 3, further comprising:
outputting a warning upon ascertaining, when verifying the relative position of the joining partners, an impermissible position and/or an impermissible geometry of at least one of the joining partners for joining of the joining partners.

5. The method according to claim 3,
wherein the verifying the relative position comprises specifying processing settings for joining the joining partners.

6. The method according to claim 5, further comprising:
joining the joining partners using the specified processing settings in a laser welding process.

7. The method according to claim 1,
wherein the real image is captured from a direction perpendicular to a processing plane.

8. The method according to claim 1,
wherein the false color image has a resolution corresponding to a resolution of the real image.

9. The method according to claim 1,
wherein the generating the false color image comprises assigning one of at least two predetermined colors and/or at least one intermediate shade of gray to each pixel of the real image.

10. The method according to claim 9,
wherein the assigning the one of at least two predetermined colors and/or the at least one intermediate shade of gray is based on assignment of the respective pixel to a predetermined feature class.

11. The method according to claim 1,
wherein the joining partners are metallic, rod-shaped conductor elements, which are to be welded together to form an electrical connection.

12. A laser welding device for joining two joining partners, the laser welding device comprising:
a positioning device for positioning the two joining partners in a joining position;
a laser beam source for providing a processing laser beam;
a laser welding head with laser welding optics for aligning and focusing the processing laser beam in a direction of the two joining partners;
an image capture device for capturing a real image of the two joining partners in the joining position;
an image processing device for generating a false color image based on the real image; and
a measuring device for determining at least one item of information about a position of at least one of the two joining partners, based on the false color image.

13. The laser welding device according to claim 12, further comprising:
a verification device for verifying, based on the at least one item of information, the position and/or a geometry of the at least one of the two joining partners, wherein the verification device is further configured to output a warning upon ascertaining, when verifying the position and/or the geometry, an impermissible position and/or an impermissible geometry of the at least one of the two joining partners for the joining of the two joining partners.

14. The laser welding device according to claim 13,
wherein the verification device is further configured to specify processing settings for laser welding of the two joining partners by the laser welding device based on the at least one item of information.

15. A non-transitory computer-readable medium having instructions stored thereon, the instructions, when executed by a computer processor, causing performance of a method according to claim 1 on a joining device.
